(19) United States
(12) Patent Application Publication
(10) Pub. No.: US 2007/0155424 A1
(43) Pub. Date: Jul. 5, 2007

(54) Portable communication device with changeable transmitter

(75) Inventors: Rich Gasper, Phoenix, AZ (US); Gianfranco Fiorio, Arlington, VA (US)

Correspondence Address: BRAD CLOSE;TIGHE PATTON, PLLC, 1747 PENN. AVE. NW, SUITE 300, WASHINGTON, DC, 20006-4604, US

(73) Assignee: Alpha Omega International

(21) Appl. No.: 11/639,086

(22) Filed: Dec. 14, 2006

Related U.S. Application Data
(60) Provisional application No. 60/755,579, filed on Dec. 30, 2005.

(51) Int. Cl. H04M 1/00

(52) U.S. Cl. 455/556.1

(57) ABSTRACT

A device and a method for removably installing a transmitter 6 into a portable communication device 4 that involves device that has a port for a removably attached transmitter. A new transmitter is installed and selected for. Alternately, the original transmitter may be used in a new portable communication device.

This application claims priority to U.S. provisional 60/755,579, filed Dec. 30, 2005, entitled “Portable Communication Device with Changeable Transmitter” which is incorporated herein by reference.

### BACKGROUND

Portable communication devices (PCD), such as cell phones, emailers and other devices that incorporate such technologies are restrictive in their geography and the range of networks available to particular devices. In addition to this, companies that use compatible networks often do not allow compatible devices to be switched over to their company due to legitimacy, marketing or bureaucratic concerns.

What is needed is a method and apparatus that allows cell phones, emailers and similar devices to use multiple networks, including different networks in different localities, and also would allow these devices to be upgraded with minimal difficulty. Other difficulties with the prior art also exist, some of which will be apparent upon further reading.

### SUMMARY OF THE INVENTION

With the foregoing in mind, methods and apparatuses consistent with the present invention, which inter alia facilitates the transfer of portable communication devices (PCDs) between networks and between companies includes a changeable transmitter used with the PCD. An original changeable transmitter can be located within the device itself or peripherally attached. At least one additional transmitter then needs to be introduced to the PCD, and a swich to the new transmitter is made. In some cases the new transmitter physically replaces the original, in which case the act of making the switch can serve as the selection to the new transmitter. In other cases the addition of the new transmitter switching automatically acts as the selection to the new transmitter, even if the original transmitter is still present.

The transmitter will contain at least an electronic serial number (ESN) and the transmitting and receiving hardware for a particular network frequency. The transmitter may also include specific chips that carry personal data. If present, these data chips (DCS), such as a SIM chip, may be severable from the transmitters. Other chips, such as those used to boost signal strength, may also be part of or severable from the transmitter.

By switching transmitters, users retain their PCDs when they wish to switch networks, or even between companies on the same network. This allows for a quick and simple change and does not require, for example, getting a new phone when cellular providers are switched. Data, settings and other features are kept, as well as the bulk of the actual device itself. This greatly reduces cost, time, bureaucracy and waste. Further advantages also include the temporary switching of transmitters. For example, when users are in a foreign location, switching the transmitter on their PCD will allow them to use foreign networks on their familiar devices.

In addition to this, users may conversely keep their transmitters and upgrade the PCDs around them. This can be done to truly upgrade a device, but can also be done for temporary upgrades in capabilities. For example, a users wishes to have the latest cell phone. Without needing to switch services or inform network provides, the user will remove the existing transmitter from their existing phone and put it into the new phone; the new phone will then be ready to use with little or no extra procedures. In another example a user of a cell phone wishes to send information not supported by their phone. The user removes the transmitter from their phone, inserts it into a PDA or laptop/notebook, performs the desired work, and then reinstalls the transmitter back into the phone.

Other embodiments of the present invention also exist, which will be apparent upon further reading of the detailed description.

### BRIEF DESCRIPTION OF THE FIGURES

The invention is explained in more detail by way of example with reference to the following drawings:

FIG. 1 illustrates a series of steps in removing and reinstalling transmitters according to various embodiments of the present invention.

### DETAILED DESCRIPTION OF THE INVENTION

The present invention provides for a portable communication device (PCD) with a changeable transmitter. In the prior art, it was not possible to use a single PCD in different networks. This is due to the hardware in the PCD's transmitter being specific to a particular frequency. In order for a user to change networks in the prior art, it was required that they change the entirety of their PCD. With the present invention only the transmitter need be switched to change service. Alternately, a PCD may be upgraded by only switching out the transmitter.

As used herein, a PCD refers to any portable telecommunication device used that uses a transmitter for transmitting and receiving communications data. Communications data comprises audio, video and text, though not necessarily all at any given time. Specific examples include cellular phones, video and streaming video cameras and emailers. Emailers tend to be PDAs, notebooks and similar devices, although advancements in technology will continue to blur the distinctiveness between classes.

The transfer of PCDs between networks and between companies includes a changeable transmitter used with the PCD. An original changeable transmitter can be located within the device itself or peripherally attached. At least one additional transmitter then needs to be introduced to the PCD, and a selection to the new transmitter is made. In some cases the new transmitter physically replaces the original, in which case the act of making the switch can serve as the selection to the new transmitter. In other cases the addition of the new transmitter automatically acts as the selection to the new transmitter, even if the original transmitter is still present.

The transmitter will contain at least an electronic serial number (ESN) and the transmitting and receiving hardware for a particular network frequency. The transmitter may also include specific chips that carry personal data. If present, these data chips (DCS) may be severable from the transmitters; which is useful when upgrading the PCD or when using a transmitter in another device. Other components of the transmitter, such as those used to boost signal strength, signal amplification, etc, may also be part of or severable from the transmitter.

Although transmitters can use multiple frequencies, this is essentially putting two transmitters together. It would increase the hardware and require an additional ESN. Semantically then, transmitters are single units that work on one frequency. Transmitters that work on multiple frequencies are “two-in-one” or “many-in-one” combinations that are essentially made out of multiple single unit transmitters. If a transmitter is referred to as carrying multiple frequencies it is understood to be one of these types of combination units.

The removable transmitters should have a standard platform that is recognizable between PCDs, which includes standard power. For example, a five pin port would include, vcc, ground, transmit and receive, and rf ground. Although the transmitters may be attached through a periphery device that connects to the main PCD by an external port, which may also use an extension cable, certain embodiments will have the transmitters integrally connected via an internal port, thus requiring them to be “popped” in and out. Buttons, switches and other physical devices can be used to do this as will be apparent to one of ordinary skill in the art. This exchange of transmitters will require a certain amount of uniformity in transmitter size, which will be aided by a uniform transmitter packaging.

By switching transmitters, users retain their PCDs when they wish to switch networks, or even between companies on the same network. This allows for a quick and simple change and does not require, for example, getting a new phone when cellular providers are switched. Data, settings and other features are kept, as well as the bulk of the actual device itself. This greatly reduces cost, time, bureaucracy and waste. Not only can the bulk of a PCD be saved by switching transmitter, the transmitters themselves can be returned to the supplier for reuse. Waste in the form of tech junk, such as cell phones and their component parts are environmental hazards and produce tons of waste each year. The present invention will also increase the competition in the market place for PCDs since it will reduce the burden of switching companies.

It is common in the telecom industry that even when PCDs are compatible on certain networks, that various companies often do not let users switch to their company and keep the user's existing PCD. Even though a particular PCD would be compatible on a different company's/provider's network, a company might not let them switch because they have concerns about the veracity of the potential user's PCD. In addition, there might be marketing or bureaucratic concerns. With the present invention, companies can verify and/or supply the essential transmitter part, thus allowing users to switch between these more restrictive companies without having to change the bulk of their PCD.

Further advantages also include the temporary switching of transmitters. For example, when users are in a foreign location, switching the transmitter on their PCD will allow them to use foreign networks on their familiar devices. Foreign location, for the purposes of the present invention, means any location where a difference in networks is present. Although this will often mean actual foreign countries, it can also mean domestic and even local locations where network services differ. This definition is typified by the following illustrative example. A user goes to a foreign country where his cell phone receives no service, or at best an expensive roaming service. He obtains a transmitter that performs better at this new location, and continues to use his own phone in this foreign country. In another example, a user has a preferred phone network, but gets bad reception in a particular area at work. When the user is in this area he switches transmitters to obtain better service, but switches back to his preferred network when he leaves. Billing packages, such as “pay-as-you-go” will be particularly suited to this type of use.

As PCDs become more and more complicated, the learning curve on any particular model is considerable. By use of the present invention, wasted effort in switching needlessly from one PCD to another can be totally avoided, saving much time and energy. Since the transmitter is being replaced, the ESN will also be changed. The user's phone number may be kept by reassigning them to the new transmitter as is known in the art.

In addition to the uses discussed above, users may conversely keep their transmitters and upgrade the PCDs around them. This can be done to truly upgrade a device, but can also be done for temporary upgrades in capabilities. For example, a user wishes to have the latest cell phone. Without needing to switch services or inform network provides, the user will remove the existing transmitter from their existing phone and put it into the new phone; the new phone will then be ready to use with little or no extra procedures, including retention of the original phone number. In another example a user of a cell phone wishes to send information over another device, for example, if the information not supported or easily sent by their phone. The user removes the transmitter from their phone, inserts it into a PDA or laptop/notebook, performs the desired work, and then, when they wish to, reinstalls the transmitter back into the phone. It is also possible to receive phone calls into the laptop with the laptop is so equipped. Not supported may mean lacking the capabilities, such as inability to send email, or it may mean deficient in the interface, such as the lack of an ergonomic keyboard. The addition of a DCS is particularly suited to these applications where a transmitter is kept and used in other devices.

By use of the present invention, there will be provided PCDs that do not contain original transmitters, but are capable of receiving transmitters. Similarly, transmitters will be made available that are not packaged with a PCD. Multiple PCD devices can be packaged with the same transmitter. A cell phone and a notebook can be sold as a package and one transmitter will be interchangeable between the two.

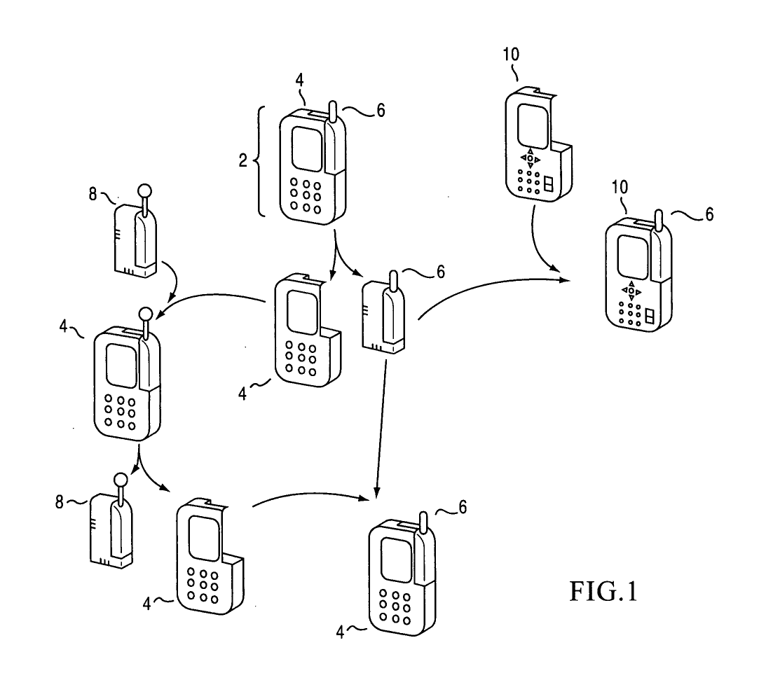

FIG. 1 illustrates several of the concepts discussed in relation to a cell phone. A user begins 2 with a cell phone 4 with attached transmitter 6. The transmitter contains all needed RF items to broadcast a wireless signal, which includes an ESN and in some cases other data chips. In the embodiment illustrated the transmitter includes the antenna and is located on the upper side of the cell phone, though neither of these features are necessary, and the transmitter may be located wholly within in the body of the cell phone. The transmitter can even be popped wholly in and out of the cell phone frame, thus leaving minimal external evidence of its removal. The cell phone 4 and the transmitter 6 are then separated, though in some cases a user may begin with a transmitterless phone.

The phone 4 can then be combined with a new transmitter 8 based on the wireless carrier desired. This will allow the original cell phone to be used on the new carrier. Embodiments not illustrated are when a PCD can hold multiple transmitters. If it is desired to return to the old transmitter, then the cell phone and new transmitter are separated and the old transmitter is reinstalled. The old transmitter can also be inserted into a new phone 10, thus using new phone upgrades without changing carriers.

In one embodiment the present invention provides for a method for removably installing a transmitter into a PCD that comprises obtaining a PCD; the PCD has a port for a removably attached transmitter. Then installing a transmitter comprising an ESN and hardware for receiving and transmitting on a specific frequency, and selecting for the transmitter.

In particular embodiments the port is at least one of an external port and internal port. The PCD may be a cell phone or emailer, and in some PCDs may use multiple transmitters.

In another embodiment the present invention provides for a PCD that comprises a user interface, and other PCD features, and a removably attached transmitter. The transmitter comprises an ESN and hardware for receiving and transmitting on a specific frequency. A transmitter is installed on the PCD and the PCD is selected to use the new transmitter. In particular embodiments, the transmitter is removed in order to install the new transmitter.

In still another embodiment the present invention provides for a PCD that comprises a user interface, and other PCD features, and a removably attached transmitter. The transmitter comprises an ESN and hardware for receiving and transmitting on a specific frequency. The transmitter is removed from the PCD and installed onto a new PCD, whereby the transmitter maintains the ESN and continues to receive and transmit on the specific frequency. In particular embodiments, installing the transmitter onto the new PCD involves inserting the transmitter into the new PCD.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. A method for removably installing a transmitter into a PCD comprising:
obtaining a PCD, wherein said PCD has a port for with a removably attached transmitter;
removing said transmitter;
installing a second transmitter comprising an ESN and hardware for receiving and transmitting on a specific frequency; and
selecting for said second transmitter.

2. The method of claim 1, wherein said port is at least one of an external port and internal port.

3. The method of claim 1, wherein said PCD is a cell phone.

4. The method of claim 1, wherein said PCD is an emailer.

5. The method of claim 1, multiple transmitters are used in a single PCD.

6. The method of claim 1, further comprising removing said second transmitter and reinstalling said transmitter in said PCD.

7. A PCD comprising:
a user interface; and
a removably attached transmitter, said transmitter comprising an ESN and hardware for receiving and transmitting on a specific frequency;
wherein said removably attached transmitter is capable of being removed by a user and a second transmitter is capable of being installed on said PCD, and said PCD is able to select said new transmitter for use.

8. The PCD of claim 7, wherein said removably attached transmitter is removed in order to install said second transmitter.

9. A PCD comprising:
a user interface; and
a removably attached transmitter, said transmitter comprising an ESN and hardware for receiving and transmitting on a specific frequency;
wherein said transmitter is removed from said PCD and installed onto a new PCD, whereby said transmitter maintains said ESN and continues to receive and transmit on said specific frequency.

10. The PCD of claim 9, wherein installing said transmitter onto said new PCD involves inserting said transmitter into said new PCD.

11. The PCD of claim 9, wherein said transmitter is capable of being removed from said new PCD and reinstalled in said PCD.

12. The PCD of claim 11, wherein said PCD is a cell phone and wherein said new PCD is at least one of a notebook and a PDA.

13. The PCD of claim 11, wherein a data chip is integral with the transmitter.

14. The PCD of claim 9, wherein said PCD is a cell phone and said new PCD is an upgraded cell phone, whereby a user upgrades their cell phone.

15. The PCD of claim 14, wherein a data chip is integral with the transmitter.
